(19) United States
(12) Patent Application Publication
(10) Pub. No.: US 2023/0205793 A1
(43) Pub. Date: Jun. 29, 2023

(54) METHOD OF DETERMINING SET OF ASSOCIATION GRIDS, ELECTRONIC DEVICE, AND STORAGE MEDIUM

(71) Applicant: Apollo Intelligent Connectivity (Beijing) Technology Co., Ltd., Beijing (CN)

(72) Inventors: Xiaokang GUO, Beijing (CN); Chong GUO, Beijing (CN)

(21) Appl. No.: 18/111,999

(22) Filed: Feb. 21, 2023

(30) Foreign Application Priority Data
Mar. 11, 2022 (CN) 202210238461.7

(51) Int. Cl. G06F 16/29

(52) U.S. Cl. CPC G06F 16/29

(57) ABSTRACT

A method of determining a set of association grids, an electronic device, and a storage medium are provided, which relate to a field of computer technology, in particular to fields of Internet of Things, Internet of Vehicles, and big data. A specific implementation includes: gridding a map to obtain a set of candidate grids; selecting a starting grid from the set of candidate grids; performing, based on the starting grid, a filtering operation for determining an existence or a non-existence of a geographic association relationship on the set of candidate grids, to obtain an association grid; repeatedly performing, in response to a determination that the association grid does not meet a condition, the filtering operation by using the association grid, until an obtained association grid meets the condition; and merging the association grid obtained by each filtering operation with the starting grid to obtain a set of association grids.

### CROSS-REFERENCE TO RELATED APPLICATION(S)

This application claims the benefit of Chinese Patent Application No. 202210238461.7 filed on Mar. 11, 2022, the whole disclosure of which is incorporated herein by reference.

### TECHNICAL FIELD

The present disclosure relates to a field of a computer technology, in particular to fields of the Internet of Things, the Internet of Vehicles, and big data. Specifically, the present disclosure relates to a method of determining a set of association grids, an electronic device, and a storage medium.

### BACKGROUND

A concept of a grid is widely used in various fields, and a set of grids is a collection of grids with some common features. The set of grids may be used to achieve a statistics of a certain type of grid, which is convenient for subsequent batch operations, such as a feature definition, an operation application and a result display, etc., so it is widely used. It is an urgent problem to be solved in this field to automatically and quickly extract grids with a geographic association relationship from a large number of grids to form a set of grids.

### SUMMARY

The present disclosure provides a method of training a ranking model, and an electronic device.

According to an aspect of the present disclosure, a method of determining a set of association grids is provided, including: gridding a map to obtain a set of candidate grids; selecting a starting grid from the set of candidate grids; performing, based on the starting grid, a filtering operation for determining an existence or a non-existence of a geographic association relationship on the set of candidate grids, so as to obtain an association grid; repeatedly performing, in response to a determination that the association grid does not meet a predetermined condition, the filtering operation for determining the existence or the non-existence of the geographic association relationship by using the association grid as a current grid, until an obtained association grid meets the predetermined condition; and merging the association grid obtained by each filtering operation with the starting grid to obtain a set of association grids for the set of candidate grids.

According to another aspect of the present disclosure, a method of determining a target region based on a set of association grids is provided, including: obtaining the set of association grids according to any of the methods described above; and determining the set of association grids as a target region in the map, so as to identify that grids in the target region have a geographic association relationship.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method in any one of embodiments of the present disclosure.

According to another aspect of the present disclosure, a non-transitory computer-readable storage medium having computer instructions therein is provided, and the computer instructions are configured to cause a computer to implement the method in any one of embodiments of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic flowchart of a method of determining a set of association grids according to embodiments of the present disclosure;

FIG. 2 shows a schematic flowchart of a method of determining a set of association grids according to other embodiments of the present disclosure;

FIG. 3 shows a flowchart of a process of determining a set of association grids according to embodiments of the present disclosure;

FIG. 4 shows a flowchart of a process of determining a set of association grids according to other embodiments of the present disclosure;

FIG. 5 shows a flowchart of a method of determining a target region based on a set of association grids according to embodiments of the present disclosure;

FIG. 6 shows a schematic diagram of an apparatus of determining a set of association grids according to embodiments of the present disclosure;

FIG. 7 shows a schematic diagram of an apparatus of determining a target region based on a set of association grids according to embodiments of the present disclosure; and

FIG. 8 shows a block diagram of an electronic device for implementing a method of determining a set of association grids according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The term “and/or” herein merely describes an association relationship of associated objects, which means that there may be three relationships. For example, A and/or B may refer to only A, A and B, or only B. The term “at least one” herein means any one of a plurality or any combination of at least two of a plurality. For example, including at least one selected from A, B or C may mean including any one or more selected from a set formed by A, B and C. The terms “first” and “second” herein refer to and distinguish a plurality of similar technical terms, and do not mean to limit an order or limit as only two. For example, a first feature and a second feature refer to two types of features/two features, the first feature may include one or more features, and the second feature may also include one or more features.

In addition, in order to better describe the present disclosure, many specific details are given in the following specific embodiments. Those skilled in the art may understand that the present disclosure may be implemented without some of the specific details. In some examples, methods, means, components and circuits well known to those skilled in the art are not described in detail so as to highlight a subject matter of the present disclosure.

In a real-world scenario, a map is generally divided into a plurality of grids. After the map is divided into the plurality of grids, the grids may be classified according to relevant information or attribute information of the grids, so as to obtain some grids belonging to a same category. After classification, it is generally needed to determine whether the grids of the same category are connected directly, in other words, whether the grids of the same category may be merged into one region. After some grids (also known as valid grids) are obtained, common methods used to determine whether the grids have a geographic association relationship include an exhaustive algorithm (enumeration method) and a clustering algorithm (K-means). It should also be noted that in the present disclosure, two grids being adjacent directly (or referred to as being adjacent) means that the two grids have a common point. The geographic association of a plurality of grids means that two grids in the plurality of grids have a common point, and on the map, it means that the map grids are geographically connected. The so-called set of association grids means that the grids in the set of grids are connected directly or indirectly.

A basic idea of the exhaustive method is to enumerate all possible cases, and determine the ones meeting a condition required to solve a question, so as to obtain all answers to the question. The exhaustive method takes advantage of characteristics of a fast computing speed and a high accuracy of a computer to check all possible cases to solve the question, and find out an answer meeting requirements.

When the exhaustive algorithm is used to solve the question, the following two aspects are generally analyzed.

(1) Cases involved in the question, including: what cases are involved in the question, and whether a number of types of the cases may be determined. The cases may be described. When the exhaustive algorithm is used, a limited types of cases involved in the question need to be enumerated one by one, without repetition or omission. The repetition of enumeration may directly lead to an extraneous solution and affect an accuracy of the solution; while the omission of enumeration may lead to an omission of the solution.

(2) A condition that the answer needs to meet, that is, the case obtained by analysis may be an answer to the question only when it meets the condition.

For a specific question of “how to determine whether valid grids are associated or not”, the exhaustive algorithm needs to find out directly adjacent grids, and then sequentially determine whether the grids meet the condition (that is, whether the grids are valid), and if so, determine whether a grid directly adjacent to the directly adjacent grids meets the condition, and repeatedly perform the operation until there is no valid adjacent grid.

In an example, assuming that grid No. 2 is used as a starting grid, it is possible to search for a valid grid associated with the starting grid, and form all associated valid grids into a grid group, which is typically performed according to the following steps.

In step 1, grids directly adjacent to grid No. 2 are obtained to generate a directly adjacent grid matrix for grid No. 2.

| | | |
|---|---|---|
| [8 | 9 | 10, |
| 1 | 2 | 3, |
| −6 | −5 | −4] |

In step 2, starting from grid No. 8, a directly adjacent grid matrix for the grid No. 8 is generated.

| | | |
|---|---|---|
| [14 | 15 | 16 |
| 7 | 8 | 9, |
| 0 | 1 | 2] |

In step 3, it is determined whether there is a valid directly-adjacent grid for grid No. 8, if so, the generation continues; if not, the generation of grid is terminated and the search is stopped.

In step 4, the process returns to step 1, the operations of step 2 and step 3 are performed on grid No. 9, and so on.

In step 5, when no new valid adjacent grids are generated, all directly adjacent grids are aggregated to obtain a final set of grids with geographic association.

A biggest disadvantage of searching by using the exhaustive method is a large amount of calculation and a low search efficiency. In a case of a large exhaustive range, it may consume a lot of time, that is, a time cost is unbearable.

In a case of using the clustering algorithm, a K-means algorithm is generally used. An idea of the K-means algorithm is typically to input a set of samples (or called a set of points), and cluster the samples through this algorithm so that the samples with similar features are clustered into one category. During the clustering process, for each point, a center point closest to that point among all center points may be calculated, and then that point is classified into a cluster represented by that center point. After an iteration, it is possible to recalculate the center point for each cluster, and then re-find the closest center point for each point. Such operations may be performed repeatedly until the clusters of the previous and subsequent iterations remain unchanged.

Basic steps of the K-means algorithm are as follows.

In step 1, a number k of categories to be clustered (for example, k=3 as above) is determined, and k center points are selected.

In step 2, a closest center point is found (seeking for organization) for each sample point, and the points closest to a same center point belong to a category, thus one clustering is completed.

In step 3, it is determined whether the categories of the sample points before and after clustering are the same, if they are the same, the algorithm terminates, otherwise the process proceeds to step 4.

In step 4, for the sample points in each category, the center point of these sample points are calculated as a new center point of the category, and then step 2 continues to be performed.

Based on the above introduction, an important assumption of K-Means is that a similarity between data may be measured by a Euclidean distance. If the Euclidean distance may not be used for measurement, the data needs to be converted to the Euclidean distance for measurement. Therefore, the scenario of constructing grid groups may actually be understood as forming a cluster of grid groups that are relatively close to each other.

In an example, a specific process of the K-Means algorithm is as follows.

In step 1, k samples are selected randomly from a dataset D as initial k centroid vectors: {μ1, μ2, . . . , μk}.

In step 2, for n=1, 2, . . . , N:

A) a cluster partition C is initialized as Cₜ=Ø_{t=1, 2 . . . k};

B) for i=1, 2 . . . m, a distance dᵢⱼ=∥xᵢ−μⱼ∥22 between a sample xᵢ and each centroid vector μ_{j(j=1, 2, . . . k)} is calculated, the xᵢ is marked to the category λᵢ corresponding to the smallest dᵢⱼ, then Cλᵢ=Cλᵢ∪{xᵢ} is updated;

C) for j=1, 2, . . . , k, a new centroid μⱼ=1|Cⱼ|Σx∈Cjₓ is recalculated for all sample points in Cⱼ;

D) if all the k centroid vectors have not changed, the process may proceed to step 3.

In step 3, the cluster partition C={C₁, C₂, . . . Cₖ} is output.

The input of K-Means is the set of samples D={x₁, x₂, . . . xₘ}, the number of clusters is k, and a maximum number of iteration is N.

The output of K-Means is the cluster partition C={C₁, C₂, . . . Cₖ}.

For the service scenario of determining the set of association grids, the algorithm process of K-Means has two obvious defects.

Firstly, for the calculation of the distance between the sample and each centroid vector in step B), if all k centroid vectors have not changed, then a cluster is generated, but the distance here is an average value. Generally speaking, the points that are close to the centroid are gathered as much as possible to form a grid group. In this way, the valid grids in the grid group may be as close as possible, but a strictness of the requirement that “the valid grids are associated” may not be fully ensured.

Secondly, in the step A), the number of cluster partitions depends on the manually input k value, and the grid group calculated in this way is not necessarily consistent with the number of objectively existing grid groups.

In addition, the operation of K-Means algorithm also consumes relatively more CPU resources and requires relatively large computing power.

In summary, although the exhaustive algorithm is highly readable and easy to understand, its calculation complexity is relatively high and it is very time-consuming; while the K-Means clustering algorithm may have the problem of “inaccuracy”, and it may have high requirements for the computing power.

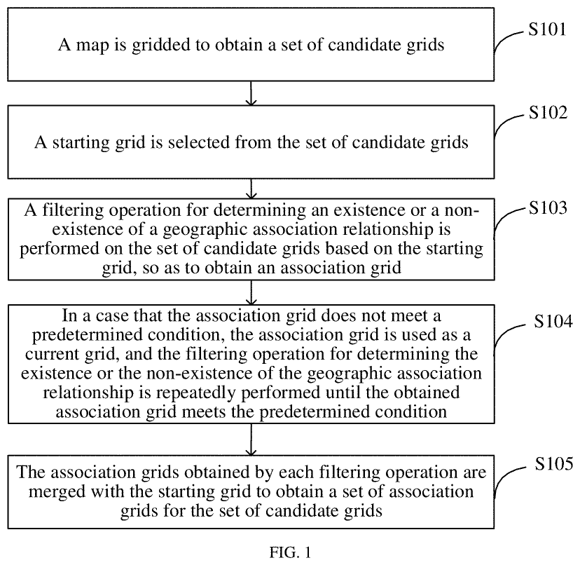

On the basis of a related art, the present disclosure provides a new method of determining a set of association grids. FIG. 1 shows a schematic flowchart of a method of determining a set of association grids according to embodiments of the present disclosure, which specifically includes the following steps.

In S101, a map is gridded to obtain a set of candidate grids.

In an example, the gridding method may be implemented to divide the map into grids of equal size according to latitude and longitude, or divide the map into grids of unequal size according to parameters of the map; a shape of the grid is not specifically limited. After gridding, the candidate grids to be determined for the geographic association may be selected to form the set of candidate grids. The selection method is not specifically limited. It is possible to select grids with common attributes to form the set of candidate grids, or select grids that have reported predetermined events to form the set of candidate grids.

In S102, a starting grid is selected from the set of candidate grids.

In an example, the set of candidate grids is a set of valid grids that have been preliminarily selected, and any grid to be determined for the geographic association relationship is selected from the set of valid grids as the starting grid.

In an example, the grid mainly refers to a map grid, and the set of candidate grids includes grids that have reported a predetermined event. Specifically, the predetermined event may be flexibly defined according to actual conditions. For example, when it is required to count accident-prone regions, the predetermined event may be defined as “at least one traffic accident has been reported within 24 hours”, and the map grids that meet the predetermined event may be collected to form the set of candidate grids. When it is required to count regions having bad road conditions, the predetermined event may be defined as “at least ten events of road bumps have been reported within one week”, and the map grids that meet the predetermined event may be collected to form the set of candidate grids. The predetermined event may be an event that conforms to a predetermined reporting frequency, a predetermined reporting time, or a predetermined event type. By the selection processing on the set of counted grids that have reported the predetermined event, it is possible to better grasp an internal feature, which is especially suitable for mining an implicit information of traffic big data.

In S103, a filtering operation for determining an existence or a non-existence of a geographic association relationship is performed on the set of candidate grids based on the starting grid, so as to obtain an association grid.

In an example, after the starting grid is obtained, a set of grids directly adjacent to the starting grid is obtained by looking up a table or other methods. Then it is determined whether the set of directly adjacent grids have an intersection with the set of candidate grids. If so, a grid in the intersection is extracted as the association grid of this filtering operation.

In S104, in a case that the association grid does not meet a predetermined condition, the association grid is used as a current grid, and the filtering operation for determining the existence or the non-existence of the geographic association relationship is repeatedly performed until the obtained association grid meets the predetermined condition.

In an example, it is determined whether the association grid meets the predetermined condition, and if not, the association grid obtained in the previous filtering operation is used as the current grid, and the filtering operation is repeatedly performed based on the current grid. Specifically, assuming that the previously obtained association grid is grid No. 2, it may be firstly determined whether the association grid meets the predetermined condition, and if not, it is possible to search for a set of all directly adjacent grids for grid No. 2. Then, it may be determined whether the set of directly adjacent grids have an intersection with the set of candidate grids, and the grid in the intersection may be used as a new association grid. It is determined whether the new association grid meets the predetermined condition, and if not, a next round of filtering operation for determining the existence or the non-existence of the geographic association relationship may be performed until the obtained latest set of association grids meets the predetermined condition.

In an example, the predetermined condition is that there is no grid with a geographic association relationship. In other words, if the set of association grids obtained by the filtering operation for determining the existence or the non-existence of the geographic association relationship is an empty set, the predetermined condition is met. Then, the process may proceed to jump out of the loop. Setting the predetermined condition as “there is no grid with a geographic association relationship” means that in the process of repeatedly performing the “filtering operation for determining the existence or the non-existence of the geographic association relationship”, if the grids directly adjacent to the current grid have no intersection with the set of candidate grids to be determined for the geographic association relationship, that is, the intersection is an empty set, it is considered that the association grid has been determined, and the execution may come out of the loop. Through the above operations, a round of filtering the association grid may be completed quickly and accurately, and it is ensured that the filtering process may not be repeated.

In an example, using the association grid as the current grid and repeatedly performing the filtering operation for determining the existence or non-existence of the geographic association relationship until the obtained association grid meets the predetermined condition may specifically include: using the previously obtained association grid as the current grid, acquiring grids adjacent to the current grid, acquiring grids other than the starting grid and each obtained association grid in the set of candidate grids as undetermined grids, acquiring an intersection of the undetermined grids and the adjacent grids, and using the intersection as the association grid obtained by the current filtering operation until the association grid obtained by the current filtering operation meets the predetermined condition. Combined with an actual case, assuming that the association grid obtained in the previous step is grid No. 2, the directly adjacent grids to grid No. 2 may be found, which may include, for example, [8,9,10,1,2, 3, −6, −5, −4]. Then, the grids other than the starting grid and each obtained association grid are selected from the candidate grids as the undetermined grids. Assuming that the initial candidate grids are [1,2,3,5,8,10], the starting grid is [10], and only one filtering operation has been previously performed to determine that the grids associated with [10] include [2,3], then the undetermined grids are [1,5,8]. Then, an intersection of the undetermined grids and the current adjacent grids is determined, that is, an intersection of the current adjacent grids [8, 9, 10, 1, 2, 3, −6, −5, −4] and the undetermined grids [1,5,8] is determined to obtain the association grid [8]. Since the association grid is not an empty set, it is needed to further find the directly adjacent grid to [8], and then a next filtering operation is performed until the obtained association grid is an empty set. By adopting the above-mentioned solution, it is possible to quickly and comprehensively filter the unit grids for the geographic association relationship, so as to obtain a set of target association grids.

In S105, the association grids obtained by each filtering operation are merged with the starting grid to obtain a set of association grids for the set of candidate grids.

In an example, a set of all grids with the geographic association relationship may be obtained by merging the starting grid and each obtained association grid.

By adopting the above-mentioned solution, the grids with direct or indirect adjacent relationship may be quickly obtained by means of cyclic filtering to generate a set of association grids. Compared with the exhaustive algorithm and the clustering algorithm commonly used in the related art, this solution has a fast speed and a high accuracy without a complicated process and without occupying too much computing power. This solution may be applied to actual scenarios to quickly extract grids with geographic association relationships from a large number of candidate grids. In particular, for a related product of the Internet of Vehicles, this solution may be applied to enrich function implementations of the related product, so that a use value of the product may be improved, and the service requirements may be met while ensuring the accuracy and stability of calculation.

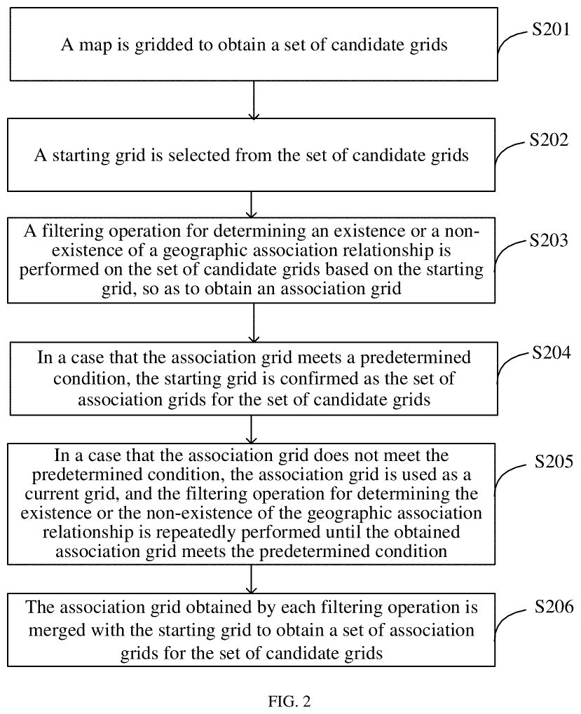

FIG. 2 shows a schematic flowchart of a method of determining a set of association grids according to other embodiments of the present disclosure, which specifically includes the following steps.

In S201, a map is gridded to obtain a set of candidate grids.

In S202, a starting grid is selected from the set of candidate grids.

In S203, a filtering operation for determining an existence or a non-existence of a geographic association relationship is performed on the set of candidate grids based on the starting grid, so as to obtain an association grid.

In S204, in a case that the association grid meets a predetermined condition, the starting grid is determined as the set of association grids for the set of candidate grids.

In S205, in a case that the association grid does not meet the predetermined condition, the association grid is used as a current grid, and the filtering operation for determining the existence or the non-existence of the geographic association relationship is repeatedly performed until the obtained association grid meets the predetermined condition.

In S206, the association grid obtained by each filtering operation is merged with the starting grid to obtain a set of association grids for the set of candidate grids.

The above steps S201 to S203, S205 and S206 are the same as S101 to S105, which will not be repeated here. It should be noted that the above step S204 needs to be performed after step S203, but there is no necessary sequence between step S204 and step S205 or S206.

In an example, if the association grid obtained by the filtering operation based on the starting grid meets the predetermined condition, that is, if the first filtering operation results in an empty set, the starting grid may be used directly as the set of association grids for the set of candidate grids. For example, for the set of candidate grids [1,2,3,5,8,10], [5] is selected as the starting grid, and the directly adjacent grids to [5] include [6,9,11], which has an empty intersection with the candidate grids, then [5] may be determined as a set of association grids for the set of candidate grids [1,2,3,5,8,10]. By using the above solution, in a case that an independent grid is contained in the set of candidate grids, it is also stored as a special set of association grids, then the processed grid may not be selected as a new starting grid in the next round of filtering operation, and a repetitive operation may be avoided.

In an example, selecting a starting grid from the set of candidate grids specifically includes the following steps.

It is determined whether a set of association grids for the set of candidate grids has been obtained; if not, any grid is selected from the set of candidate grids as the starting grid; or if so, any grid not belonging to the set of association grids is selected from the set of candidate grids as the starting grid. This example solution is mainly used in a case that the association grid has been determined from the candidate grids. It is needed to exclude the determined association grid, and then select any grid from the remaining grids to be determined for the geographic association relationship as the starting point to perform a new round of filtering of association grid. For example, for the set of candidate grids [1, 2, 3, 5, 8, 10], if it is determined that [5] does not have a geographic association relationship with any grid in the set of candidate grids, that is, [5] is contained alone in the set of association grid that has been determined, then any grid may be selected from [1,2,3,8,10] as a new starting grid to perform a new round of filtering. Certainly, if it is not determined whether the set of candidate grids has a set of association grids, any grid may be selected as the starting grid.

In one case, a plurality of sets of association grids may be contained in the set of candidate grids. For example, [8,9,10,1,2,3,−6,−5,−4] may contain association grids [8,9], [10,1,2,3], [−4] and [−6, −5], then in the process of multiple rounds of filtering, after it is determined that [8,9],[10,1,2,3] and [−4] are association grids, any one of the remaining “−6, −5” may be selected as the starting grid. In this way, it may be ensured that no repetitive filtering of association grid is performed, and an efficiency of filtering of association grids may be improved.

An application example is described as follows.

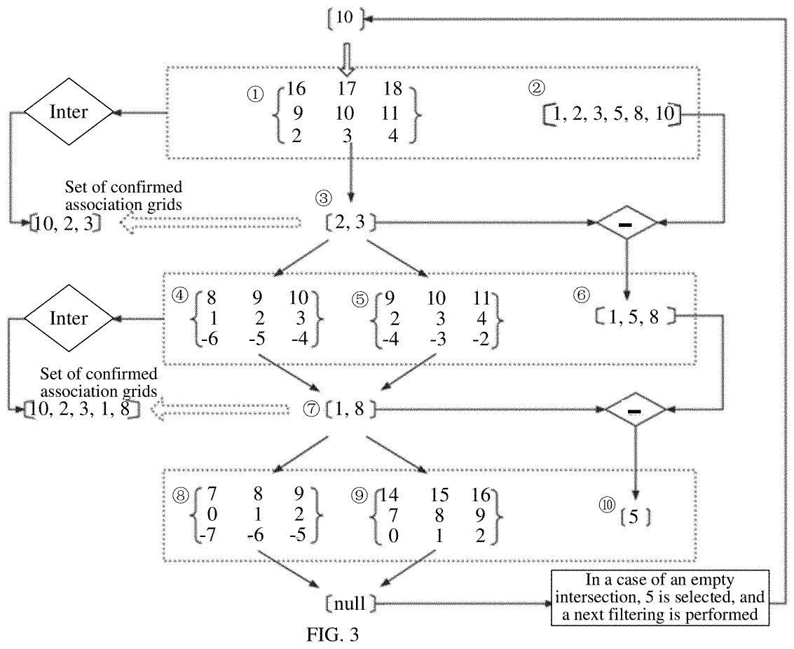

As shown in FIG. 3, a processing flow according to embodiments of the present disclosure includes the following steps.

In step 1, a grid such as grid No. 10 is selected randomly from a set of candidate grids \textcircled{2} (also called a set of valid grids), and grid No. 10 is used as a starting grid.

In step 2, grid No. 10 in \textcircled{2} is moved into a set of determined association grids (also called a grid group) on the left.

In step 3, adjacent grids \textcircled{1} (also called directly adjacent grid) to grid No. 10 are obtained by calculation.

In step 4, an intersection \textcircled{3} of \textcircled{1} and \textcircled{2} is calculated, and \textcircled{3} contains the association grids obtained by the first filtering operation.

In step 5, it is determined whether \textcircled{3} is an empty set, and a result is no, then the filtering continues. The elements of the intersection \textcircled{3} are moved into the set of determined association grids on the left, and then the set of determined association grids is [10,2,3]

In step 6, adjacent grids \textcircled{4} and \textcircled{5} to grid No. 2 and grid No. 3 are obtained respectively by calculation.

In step 7, the set of determined association grids \textcircled{3} is removed from the set of candidate grids \textcircled{2}, so as to obtain undetermined grids \textcircled{6}.

In step 8, an intersection of \textcircled{4} and \textcircled{5} and \textcircled{6} is calculated to obtain association grids \textcircled{7} for this filtering.

In step 9, it is determined whether \textcircled{7} is an empty set, and a result is no, then the filtering continues. The elements of the intersection \textcircled{7} are moved into the set of determined association grids on the left, and then the set of determined association grids is [10,2,3,1,8]

In step 10, adjacent grids \textcircled{8} and \textcircled{9} to \textcircled{7} are obtained by calculation.

In step 11, the newly determined grids \textcircled{7} are subtracted from the undetermined grids \textcircled{6} to obtain undetermined grids to \textcircled{10}.

In step 12, an intersection of \textcircled{8} and \textcircled{9} and \textcircled{10} is calculated, and a result is an empty set [null].

In step 13, since the intersection is empty, the current round of calculation is terminated, and the set of determined association grids [10, 2, 3, 1, 8] at this time is the calculated set of association grids.

In step 14, for the set of candidate grids \textcircled{2}, it is determined whether the set of determined association grids is equal to the set of candidate grids. If not, it means that there are undetermined grids. Any grid may be selected from the undetermined grids as a new starting grid. That is, No. 5 is extracted as the new starting grid, and the filtering process is performed again with reference to step 1.

In step 15, after a recursive calculation through a plurality of filtering, the set of grids not determined for the geographic association relationship on the right is finally empty, and then all calculations are terminated.

In step 16, a set of association grids greater than or equal to 0 groups is obtained as a final result.

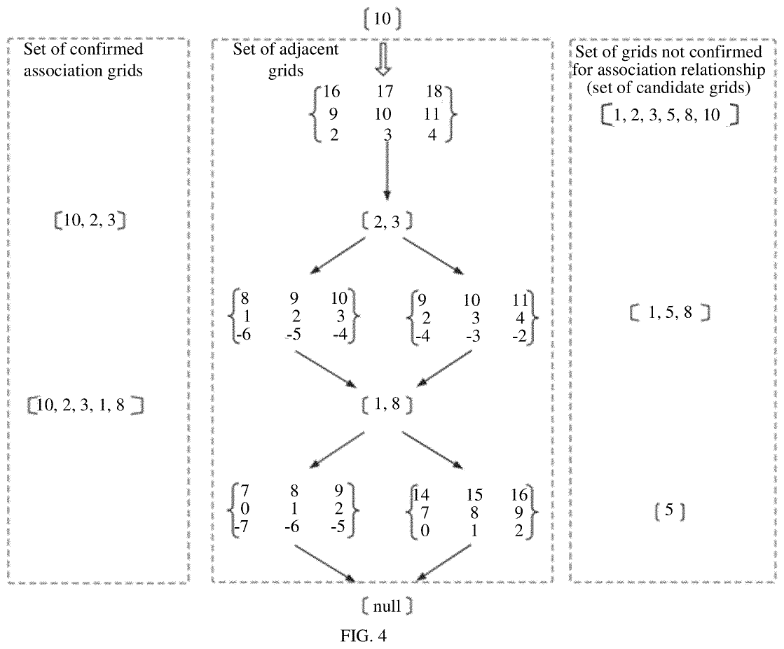

In summary, as shown in FIG. 4, this solution is to cyclically perform filtering for determining the geographic association relationship, so as to determine the set of grids not determined for the geographic association relationship in the dotted line box on the right through the set of adjacent grids in the dotted line box in the middle, and finally obtain the set of determined association grids on the left.

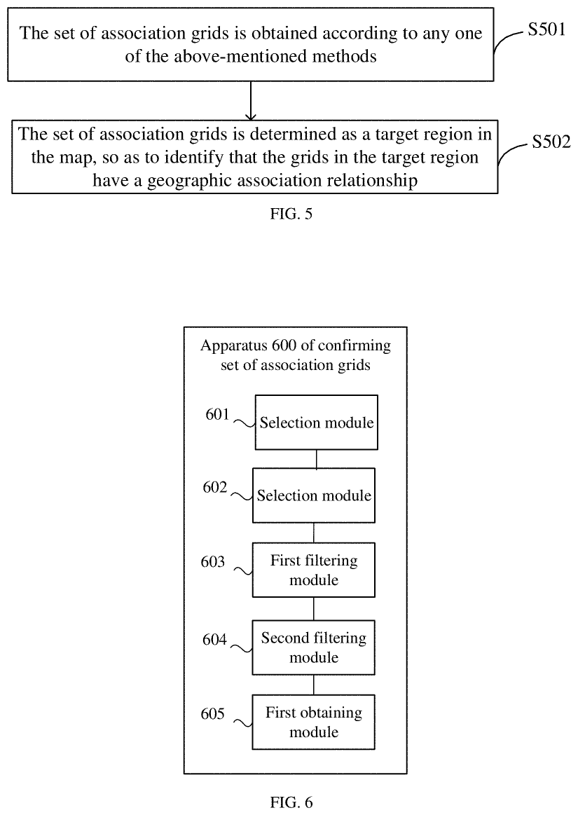

In practical applications, after the set of association grids is obtained, an association target region may be generated. As shown in FIG. 5, embodiments of the present disclosure provide a method of determining a target region based on the set of association grids, which specifically includes the following steps.

In S501, the set of association grids is obtained according to any one of the above-mentioned methods.

In S502, the set of association grids is determined as a target region in the map, so as to identify that the grids in the target region have a geographic association relationship.

In an example, after the set of association grids is obtained, a geographic location corresponding to the set of association grids may be determined as the target region in the map, that is, by determining the geographic association relationship of a plurality of grids, regions corresponding to the grids with geographic association relationship may be merged into the target region. Through the above solution, it is possible to quickly and accurately obtain the target region with a predetermined commonality, and prepare a data foundation for a management of the Internet of Vehicles. In an example, after the step S502, the method further includes transmitting a notification information to a vehicle in response to a detection that the vehicle enters the target region. The notification information corresponds to an event reported by the target region. Specifically, after the target region is obtained, a notification information may be transmitted to a vehicle if the vehicle enters the target region. The notification information is obtained according to a commonality of the target region. For example, the corresponding notification information may be obtained according to a predetermined event previously reported by the target region. Specifically, if all the candidate grids forming the target region have an event of “reporting road bumps”, then the corresponding notification message “be careful for road bumps” may be obtained and transmitted to the vehicle entering the region. Through the above solution, on the basis of receiving an information about road surface, driving and so on, the grids with a common attribute may be found using the “method of determining the set of association grids”, and merged into a set of association grids, and then the corresponding target region may be obtained. After the target region is obtained, the vehicle entering the target region may be managed according to the attribute, so that an intelligent management may be achieved.

According to technologies in the present disclosure, the target region of the map may be obtained by the method of determining the set of association grids. The target region is a collection of grids with a common feature and a physical association. After the target region is obtained, a traffic guidance or management may be carried out according to the grid feature, so as to facilitate an intelligent management of pedestrians or vehicles involved in the target region.

As shown in FIG. 6, embodiments of the present disclosure provide an apparatus 600 of determining a set of association grids, which includes the following modules.

A dividing module 601 is used to grid a map to obtain a set of candidate grids.

A selection module 602 is used to select a starting grid from the set of candidate grids.

A first filtering module 603 is used to perform, based on the starting grid, a filtering operation for determining an existence or a non-existence of a geographic association relationship on the set of candidate grids, so as to obtain an association grid.

A second filtering module 604 is used to repeatedly perform, in response to a determination that the association grid does not meet a predetermined condition, the filtering operation for determining the existence or the non-existence of the geographic association relationship by using the association grid as a current grid, until an obtained association grid meets the predetermined condition.

A first obtaining module 605 is used to merge the association grid obtained by each filtering operation with the starting grid to obtain a set of association grids for the set of candidate grids.

In an example, after the first filtering module 603, the apparatus 600 further includes a second obtaining module 606 used to determine the starting grid as the set of association grids for the set of candidate grids, in response to a determination that the association grid meets the predetermined condition.

In an example, the selection module 602 is further used to: determine whether a set of association grids for the set of candidate grids has been obtained; select a grid from the set of candidate grids as the starting grid, in response to the set of association grids for the set of candidate grids having not been obtained; and select a grid not belonging to the set of association grids from the set of candidate grids as the starting grid, in response to the set of association grids for the set of candidate grids having been obtained.

In an example, the second filtering module 604 is further used: acquire, by using a previously obtained association grid as the current grid, adjacent grids to the current grid, acquire grids other than the starting grid and each obtained association grid in the set of candidate grids as undetermined grids, acquire an intersection of the undetermined grids and the adjacent grids, and determine the intersection as the association grid obtained by a current filtering operation, until the association grid obtained by the current filtering operation meets the predetermined condition.

In an example, in any of the above-mentioned apparatuses, the predetermined condition is that no grid having the geographic association relationship is contained.

In an example, in any of the above-mentioned apparatuses, the set of candidate grids contain a grid that has reported a predetermined event.

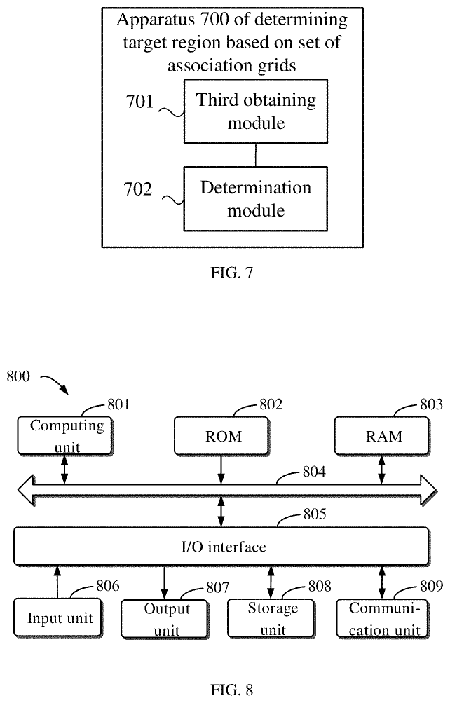

As shown in FIG. 7, embodiments of the present disclosure provide an apparatus 700 of determining a target region based on a set of association grids, which includes the following modules.

A third obtaining module 701 is used to obtain the set of association grids by using any of the above-mentioned apparatuses.

A determination module 702 is used to determine the set of association grids as a target region in the map, so as to identify that grids in the target region have a geographic association relationship.

In an example, the apparatus 700 of determining the target region based on the set of association grids further include a notification transmission module used to transmit a notification information to a vehicle in response to a detection that the vehicle enters the target region, and the notification information corresponds to an event that has been reported by the target region.

In the technical solution of the present disclosure, the collection, storage, use, processing, transmission, provision, disclosure, and application of user personal information involved comply with provisions of relevant laws and regulations, take essential confidentiality measures, and do not violate public order and good custom. In the technical solution of the present disclosure, authorization or consent is obtained from the user before the user's personal information is obtained or collected.

According to embodiments of the present disclosure, the present disclosure further provides an electronic device, a readable storage medium, and a computer program product.

FIG. 8 shows a schematic block diagram of an example electronic device 800 provided by embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the electronic device 80 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 80 to exchange information/data with other devices through a computer network such as Internet and/or various telecommunication networks.

The computing unit 801 may be various general-purpose and/or dedicated processing assemblies having processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the method of determining the set of association grids. For example, in some embodiments, the method of determining the set of association grids may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method of determining the set of association grids. Alternatively, in other embodiments, the computing unit 801 may be used to perform the method of determining the set of association grids by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak business scalability existing in a traditional physical host and VPS (Virtual Private Server) service. The server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of determining a set of association grids, comprising:
gridding a map to obtain a set of candidate grids;
selecting a starting grid from the set of candidate grids;
performing, based on the starting grid, a filtering operation for determining an existence or a non-existence of a geographic association relationship on the set of candidate grids, so as to obtain an association grid;
repeatedly performing, in response to a determination that the association grid does not meet a predetermined condition, the filtering operation for determining the existence or the non-existence of the geographic association relationship by using the association grid as a current grid, until an obtained association grid meets the predetermined condition; and
merging the association grid obtained by each filtering operation with the starting grid to obtain a set of association grids for the set of candidate grids.

2. The method according to claim 1, further comprising: after performing, based on the starting grid, a filtering operation for determining an existence or a non-existence of a geographic association relationship on the set of candidate grids, so as to obtain an association grid,
determining the starting grid as the set of association grids for the set of candidate grids, in response to a determination that the association grid meets the predetermined condition.

3. The method according to claim 1, wherein the selecting a starting grid from the set of candidate grids comprises:
determining whether a set of association grids for the set of candidate grids has been obtained;
selecting a grid from the set of candidate grids as the starting grid, in response to the set of association grids for the set of candidate grids having not been obtained; and
selecting a grid not belonging to the set of association grids from the set of candidate grids as the starting grid, in response to the set of association grids for the set of candidate grids having been obtained.

4. The method according to claim 1, wherein the repeatedly performing the filtering operation for determining the existence or the non-existence of the geographic association relationship by using the association grid as a current grid, until an obtained association grid meets the predetermined condition comprises:
acquiring, by using a previously obtained association grid as the current grid, adjacent grids to the current grid, acquiring grids other than the starting grid and each obtained association grid in the set of candidate grids as undetermined grids, acquiring an intersection of the undetermined grids and the adjacent grids, and determining the intersection as the association grid obtained by a current filtering operation, until the association grid obtained by the current filtering operation meets the predetermined condition.

5. The method according to claim 1, wherein the predetermined condition is that no grid having the geographic association relationship is contained.

6. The method according to claim 1, wherein the gridding a map to obtain a set of candidate grids comprises:
gridding the map and selecting a grid that has reported a predetermined event, so as to obtain the set of candidate grids.

7. A method of determining a target region based on a set of association grids, comprising:
obtaining the set of association grids according to the method of claim 1; and
determining the set of association grids as a target region in the map, so as to identify that grids in the target region have a geographic association relationship.

8. The method according to claim 7, further comprising:
sending a notification information to a vehicle in response to a detection that the vehicle enters the target region, wherein the notification information corresponds to an event that has been reported by the target region.

9. An electronic device, comprising:
at least one processor; and
a memory communicatively connected to the at least one processor, wherein the memory stores instructions executable by the at least one processor, and the instructions, when executed by the at least one processor, cause the at least one processor to:
grid a map to obtain a set of candidate grids;
select a starting grid from the set of candidate grids;
perform, based on the starting grid, a filtering operation for determining an existence or a non-existence of a geographic association relationship on the set of candidate grids, so as to obtain an association grid;
repeatedly perform, in response to a determination that the association grid does not meet a predetermined condition, the filtering operation for determining the existence or the non-existence of the geographic association relationship by using the association grid as a current grid, until an obtained association grid meets the predetermined condition; and
merge the association grid obtained by each filtering operation with the starting grid to obtain a set of association grids for the set of candidate grids.

10. The electronic device according to claim 9, wherein the at least one processor is further configured to: after performing, based on the starting grid, a filtering operation for determining an existence or a non-existence of a geographic association relationship on the set of candidate grids, so as to obtain an association grid,
determine the starting grid as the set of association grids for the set of candidate grids, in response to a determination that the association grid meets the predetermined condition.

11. The electronic device according to claim 9, wherein the at least one processor is further configured to:
determine whether a set of association grids for the set of candidate grids has been obtained;
select a grid from the set of candidate grids as the starting grid, in response to the set of association grids for the set of candidate grids having not been obtained; and
select a grid not belonging to the set of association grids from the set of candidate grids as the starting grid, in response to the set of association grids for the set of candidate grids having been obtained.

12. The electronic device according to claim 9, wherein the at least one processor is further configured to:
acquire, by using a previously obtained association grid as the current grid, adjacent grids to the current grid, acquire grids other than the starting grid and each obtained association grid in the set of candidate grids as undetermined grids, acquire an intersection of the undetermined grids and the adjacent grids, and determine the intersection as the association grid obtained by a current filtering operation, until the association grid obtained by the current filtering operation meets the predetermined condition.

13. The electronic device according to claim 9, wherein the predetermined condition is that no grid having the geographic association relationship is contained.

14. The electronic device according to claim 9, wherein the at least one processor is further configured to:
grid the map and select a grid that has reported a predetermined event, so as to obtain the set of candidate grids.

15. An electronic device, comprising:
at least one processor; and
a memory communicatively connected to the at least one processor, wherein the memory stores instructions executable by the at least one processor, and the instructions, when executed by the at least one processor, cause the at least one processor to:
obtain the set of association grids according to the electronic device of claim 9; and
determine the set of association grids as a target region in the map, so as to identify that grids in the target region have a geographic association relationship.

16. The electronic device according to claim 15, wherein the at least one processor is further configured to:
send a notification information to a vehicle in response to a detection that the vehicle enters the target region, wherein the notification information corresponds to an event that has been reported by the target region.

17. A non-transitory computer-readable storage medium having computer instructions therein, wherein the computer instructions are configured to cause a computer to:
grid a map to obtain a set of candidate grids;
select a starting grid from the set of candidate grids;
perform, based on the starting grid, a filtering operation for determining an existence or a non-existence of a geographic association relationship on the set of candidate grids, so as to obtain an association grid;
repeatedly perform, in response to a determination that the association grid does not meet a predetermined condition, the filtering operation for determining the existence or the non-existence of the geographic association relationship by using the association grid as a current grid, until an obtained association grid meets the predetermined condition; and
merge the association grid obtained by each filtering operation with the starting grid to obtain a set of association grids for the set of candidate grids.

18. The non-transitory computer-readable storage medium according to claim 17, wherein the computer instructions are further configured to cause the computer to: after performing, based on the starting grid, a filtering operation for determining an existence or a non-existence of a geographic association relationship on the set of candidate grids, so as to obtain an association grid,
determine the starting grid as the set of association grids for the set of candidate grids, in response to a determination that the association grid meets the predetermined condition.

19. The non-transitory computer-readable storage medium according to claim 17, wherein the computer instructions are further configured to cause the computer to:
determine whether a set of association grids for the set of candidate grids has been obtained;
select a grid from the set of candidate grids as the starting grid, in response to the set of association grids for the set of candidate grids having not been obtained; and
select a grid not belonging to the set of association grids from the set of candidate grids as the starting grid, in response to the set of association grids for the set of candidate grids having been obtained.

20. A non-transitory computer-readable storage medium having computer instructions therein, wherein the computer instructions are configured to cause a computer to:
obtain the set of association grids according to the non-transitory computer-readable storage medium of claim 17; and
determine the set of association grids as a target region in the map, so as to identify that grids in the target region have a geographic association relationship.
